(19) United States
(12) Patent Application Publication
(10) Pub. No.: US 2013/0043154 A1
(43) Pub. Date: Feb. 21, 2013

(54) CONTAINER FOR TOOL BITS

(71) Applicant: Tzu-Chien Wang, Tainan City (TW)

(72) Inventor: Tzu-Chien Wang, Tainan City (TW)

(21) Appl. No.: 13/211,468

(22) Filed: Aug. 17, 2011

(51) Int. Cl. B25H 3/00

(52) U.S. Cl. 206/349

(57) ABSTRACT

A container for tool bits includes a casing, multiple bit seats pivotally connected with the casing, and a hanger connected with the casing. The casing has a back plate, a bottom plate extending from the bottom of the back plate and being perpendicular to the back plate, multiple partition plates extending from the back plate and being respectively perpendicular to the back plate and the bottom plate and multiple cavities respectively defined between the partition plates. Each cavity has two first buckles extending form two inner sides of the cavity. The bit seats are respectively mounted in the cavities, and each bit seat has two second buckles formed on two sides of the bit seat. The hanger has a through hole defined through the hanger.

### BACKGROUND OF THE INVENTION

1. Field of the Invention

The present invention relates to a container, and more particularly to a container for tool bits

2. Description of Related Art

A conventional detachable screwdriver includes a tool handle having a connecting end disposed on the tool handle for assembling with various tool bits. Therefore, a user can go to work and simply carry the tool handle with a box receiving various tool bits. The tool handle can be assembled with any one of the tool bits for corresponding to different operational situations.

When being displayed for sale, multiple tool bits of various sizes and types are usually stored in a container and hung on a displaying rack. The conventional container includes a box and a transparent cover pivotally mounted on the box. The tool bits are arranged in the box and the cover covers the box such that the user can easily observe and choose the tool bits in the box via the transparent cover.

However, the tool bits are lying in the box of the conventional container. The user is not able to easily take a chosen tool bit from the box. Therefore, the structure of the conventional container is necessary to be improved.

To overcome the shortcomings, the present invention tends to provide a container to mitigate or obviate the aforementioned problems.

### SUMMARY OF THE INVENTION

The main objective of the invention is to provide an improved container for tool bits, which includes a casing, multiple bit seats pivotally connected with the casing, and a hanger connected with the casing.

The casing has a back plate, a bottom plate extending from the back plate, multiple partition plates extending from the bottom plate and connecting with the back plate, and multiple cavities respectively defined between the partition plates. The back plate has a front side, a rear side opposite to the front side of the back plate, a top end and a bottom end opposite to the top end of the back plate. The bottom plate extends from the bottom end of the back plate, is perpendicular to the back plate and has an inner side and an outer side opposite to the outer side of the bottom plate. The partition plates extend from the inner side of the bottom plate and connect with the front side of the back plate, and each partition plate is perpendicular to the back plate and the bottom plate. Each cavity is defined between adjacent two of the partition plates and has two first buckles respectively formed on two inner sides of the cavity and respectively extending from adjacent two of the partition plates. The bit seats are respectively mounted in the cavities such that each bit seat is able to outwardly pivot relative to the casing. Each bit seat has two second buckles formed on two sides of the bit seat for buckling with the two first buckles of a corresponding cavity and a holder disposed on an inner side of the bit seat for holding a tool bit. The hanger is connected with the top end of the back plate and has a hanging hole defined through the hanger.

Other objects, advantages and novel features of the invention will become more apparent from the following detailed description when taken in conjunction with the accompanying drawings.

### BRIEF DESCRIPTION OF THE DRAWINGS

FIG. 1 is a partially exploded perspective view of a container with tool bits in accordance with the present invention;

FIG. 2 is a front view of the container with tool bits in FIG. 1;

FIG. 3 is a side view in partial section of the container with tool bits along line 3-3 in FIG. 2;

FIG. 4 is a cross-sectional bottom view of the container with tool bits along line 4-4 in FIG. 3;

FIG. 5 is an operational side view of the container in FIG. 1 showing a hanger folded/unfolded over a casing; and

FIG. 6 is a cross-sectional top view of the container along line 6-6 in FIG. 2.

### DETAILED DESCRIPTION OF PREFERRED EMBODIMENT

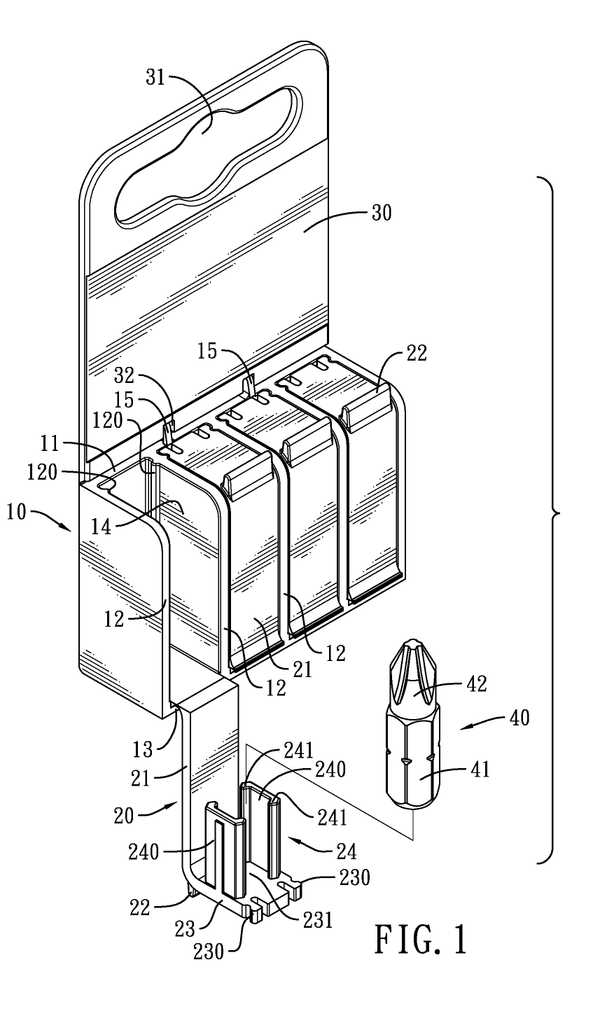

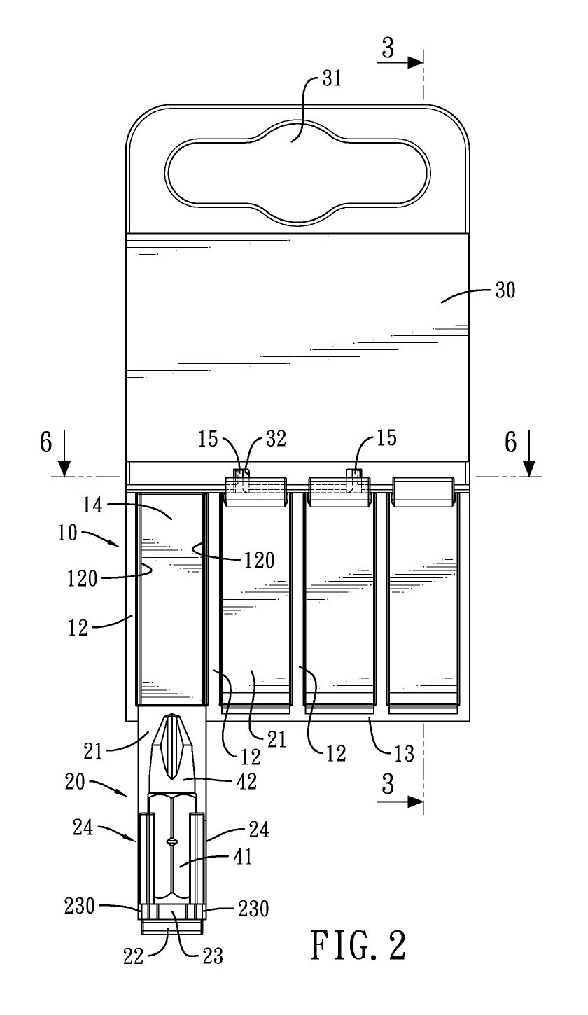

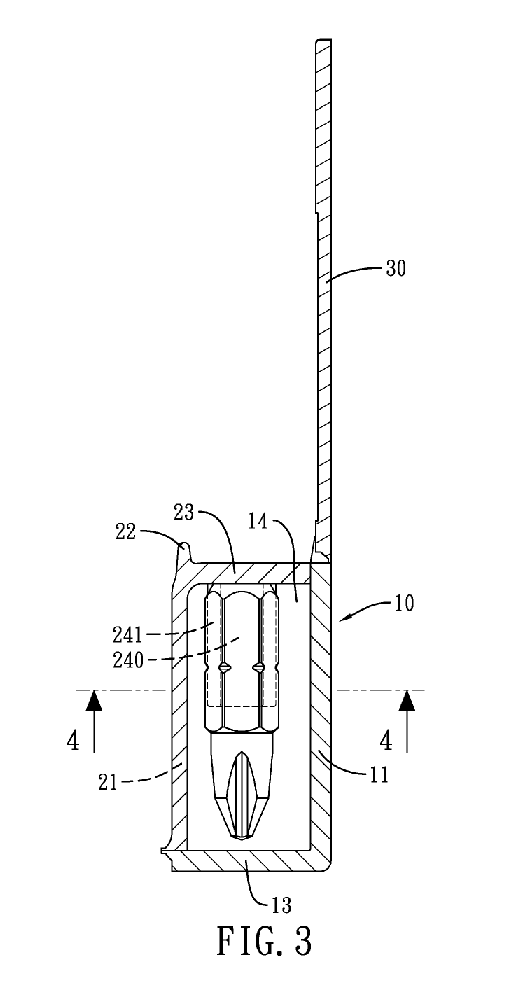

With reference to FIGS. 1-3, a container for tool bits of the present invention comprises a casing 10, a plurality of bit seats 20 mounted on the casing 10 and a hanger 30 mounted on the casing 10.

The casing has a back plate 11, a bottom plate 13 and a plurality of partition plates 12. The back plate 11 has a front side and a rear side opposite to the front side of the back plate 11. The back plate 11 has a top end and a bottom end opposite to the top end of the back plate 11. The bottom plate 13 extends from the bottom end of the back plate 11 and is perpendicular to the back plate 11. The bottom plate 13 has an inner side and an outer side opposite to the outer side of the bottom plate 13. The partition plates 12 extend from the inner side of the bottom plate 13 and connect with the front side of the back plate 11. Each partition plate 12 is perpendicular to the back plate 11 and the bottom plate 13 such that the partition plates 12 are substantially parallel to each other. A cavity 14 is defined between each adjacent two of the partition plates 12. Each cavity 14 has two first buckles 120 respectively formed on two inner sides of the cavity 14 and respectively extending from the corresponding adjacent two partition plates 12. In the preferred embodiment of the present invention, each first buckle 120 is a hook.

The bit seats 20 are pivotally connected with the casing 10 and correspondingly received in the cavities 14 such that each bit seat 20 is able to outwardly pivot relative to the casing 10. Each bit seat 20 has a front plate 21 corresponding to the back plate 11 such that each front plate 21 is substantially parallel to the back plate 11. Each front plate 21 has a first end and a second end opposite to the first end. Each front plate 21 has a puller 22 upwardly extending from the first end of the front plate 21. The second end of each front plate 21 pivotally connects with an edge of the bottom plate 13 and the first end of each front plate 21 has a top plate 23 extending from the front plate 21 for corresponding to the bottom plate 13 such that each top plate 23 is substantially parallel to the bottom plate 13. Each top plate 23 has two second buckles 230 formed on two sides of the top plate 23 for buckling with the two first buckles 120 of a corresponding cavity 14. Preferably, each second buckle 230 is a hook. Each top plate 23 has an inner side 231 selectively facing to the corresponding cavity 14. Each bit seat 20 has a holder 24 extending from the inner side 231 of the top plate 23 of the bit seat 20 and selectively received in the corresponding cavity 14 for holding a tool bit 40. In the preferred embodiment of FIG. 1, the tool bit 40 has a hexagonal body 41 and a head 42 extending from the body 41.

Each holder 24 includes two substantial parallel clamping sheets 240 facing to each other. Each clamping sheet 240 has two blockers 241 slantwise extending from two sides of the clamping sheet 240, such that each clamping sheet 240 is formed as a U-shaped cross-sectional structure.

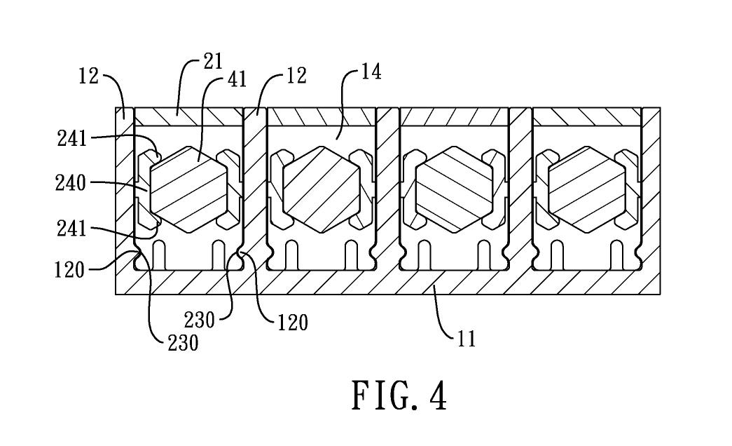

With further reference to FIG. 4, when the holder 24 of one of the bit seats 20 holds the tool bit 40, the two clamping sheets 240 of the holder 24 clip two opposite sides of the body 41 and the four blockers 241 of the two clamping sheets 240 restrict a longitudinal rotation of the body 41 such that the tool bit 40 is positioned between the clamping sheets 240.

The hanger 30 is connected with the top end of the back plate 11. The hanger 30 has a hanging hole 31 defined through the hanger 30.

When the bit seats 20 are received in the cavities 14, the two second buckles 230 of each bit seat 20 are respectively buckled with the two first buckles of the corresponding cavity 40 and the head 42 of the tool bit 40 in each bit seat 20 faces toward the bottom plate 13. When the puller 22 of one of the bit seats 20 is pulled out to pivot the bit seat 20 relative to the casing 10, the head 42 of the tool bit 40 in the bit seat 20 is straightly exhibited in the bit seat 20 and can be easily picked up. When the tool bit 40 is stored in the corresponding bit seat 20, the body 41 is inserted into the holder 24 and the bit seat 20 is pivoted and received in the corresponding cavity 14.

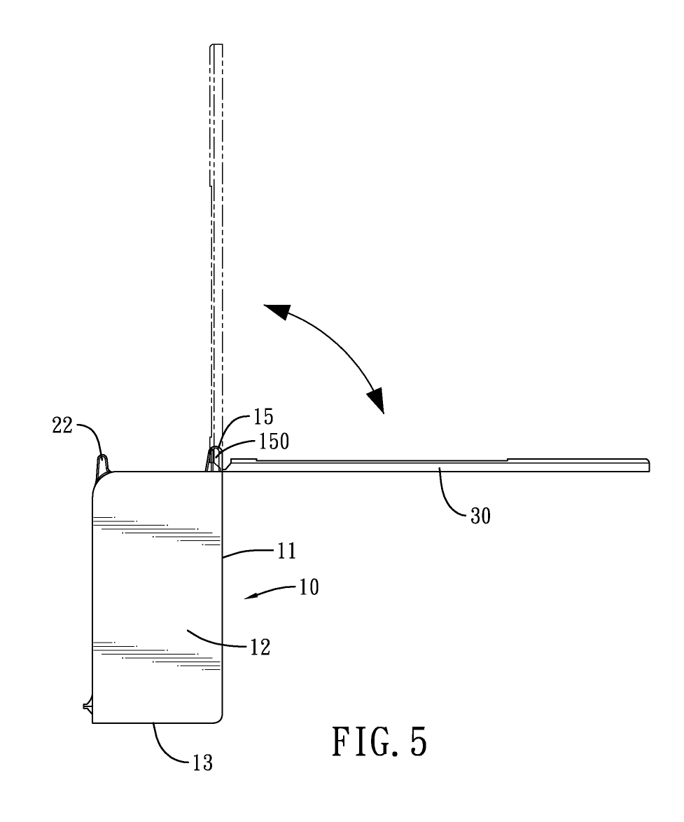

With reference to FIG. 5, preferably, the hanger 30 is pivotally connected with the top end of the back plate 11 of the casing 10 such that the hanger 30 is selectively foldable relative to the casing 10. The hanger 30 can be folded over the rear side of the back plate 11 for saving a storage space for the container.

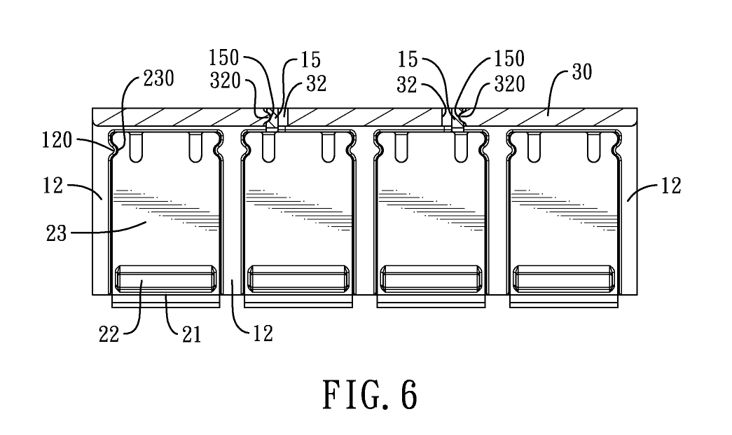

With reference to FIG. 6, the top end of the back plate 11 of the casing 10 has two ribs 15 extending from the back plate 11. Each rib 15 has a dimple 150 defined in a side of the rib 15. The hanger 30 has two orifices 32 defined in the hanger 30 for correspondingly engaging the dimples 150 of the two ribs 15. Each orifice 32 has a boss extending from an inner surface of the orifice 32 for buckling on the dimple 150 of the corresponding rib 15, such that the hanger 30 is able to be folded/unfolded over the casing 30.

The hanger 30 of the container can be hung on a display rack. The hanger 30 can also be labeled as a tag for showing the types of the tool bits 40 in the container. The casing 10 can be made of a transparent material for exhibiting the types of the tool bits 40.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A container for tool bits comprising:
a casing having
a back plate having a front side, a rear side opposite to the front side of the back plate, a top end and a bottom end opposite to the top end of the back plate;
a bottom plate extending from the bottom end of the back plate, being perpendicular to the back plate and having an inner side and an outer side opposite to the outer side of the bottom plate;
multiple partition plates extending from the inner side of the bottom plate and connecting with the front side of the back plate, and each partition plate being perpendicular to the back plate and the bottom plate; and
multiple cavities respectively defined between the partition plates, and each cavity defined between adjacent two of the partition plates and having two first buckles respectively formed on two inner sides of the cavity and respectively extending from adjacent two of the partition plates; and
multiple bit seats pivotally connected with the casing and respectively mounted in the cavities such that each bit seat is able to outwardly pivot relative to the casing, and each bit seat having
two second buckles formed on two sides of the bit seat for buckling with the two first buckles of a corresponding cavity; and
a holder disposed on an inner side of the bit seat for holding a tool bit; and
a hanger connected with the top end of the back plate and having a hanging hole defined through the hanger.

2. The container for tool bits as claimed in claim 1, wherein
each bit seat has
a front plate corresponding to the back plate and having
a first end; and
a second end opposite to the first end and pivotally connected with the bottom plate; and
a top plate connected to the first end of the front plate, corresponding to the bottom plate and having an inner side selectively facing to the corresponding cavity; and
the holder of each bit seat extends from the inner side of the top plate of the bit seat.

3. The container for tool bits as claimed in claim 2, wherein each front plate has a puller upwardly extending from the first end of the front plate.

4. The container for tool bits as claimed in claim 1, wherein each holder includes two substantial parallel clamping sheets facing to each other; and each clamping sheet has two blockers slantwise extending from two sides of the clamping sheet.

5. The container for tool bits as claimed in claim 1, wherein the hanger is pivotally connected with the top end of the back plate of the casing such that the hanger is selectively foldable relative to the casing.

6. The container for tool bits as claimed in claim 5 further comprising two ribs extending from the top end of the back plate of the casing, wherein each rib has a dimple defined in a side of the rib, the hanger has two orifices defined in the hanger for respectively engaging the dimples of the two ribs, and each orifice has a boss extending from an inner surface of the orifice for buckling on the dimple of a corresponding rib.

7. The container for tool bits as claimed in claim 6, wherein each first buckle is a hook and each second buckle is a hook such that each first buckle and a corresponding one of the second buckles are able to hook each other.

8. The container for tool bits as claimed in claim 2, wherein each holder includes two substantial parallel clamping sheets facing to each other; and each clamping sheet has two blockers slantwise extending from two sides of the clamping sheet.

9. The container for tool bits as claimed in claim 2, wherein the hanger is pivotally connected with the top end of the back plate of the casing such that the hanger is selectively foldable relative to the casing.

10. The container for tool bits as claimed in claim 4, wherein the hanger is pivotally connected with the top end of the back plate of the casing such that the hanger is selectively foldable relative to the casing.

11. The container for tool bits as claimed in claim 8, wherein the hanger is pivotally connected with the top end of the back plate of the casing such that the hanger is selectively foldable relative to the casing.

11. The container for tool bits as claimed in claim 5 further comprising two ribs extending from the top end of the back plate of the casing, wherein each rib has a dimple defined in a side of the rib, the hanger has two orifices defined in the hanger for respectively engaging the dimples of the two ribs, and each orifice has a boss extending from an inner surface of the orifice for buckling on the dimple of a corresponding rib.

12. The container for tool bits as claimed in claim 9 further comprising two ribs extending from the top end of the back plate of the casing, wherein each rib has a dimple defined in a side of the rib, the hanger has two orifices defined in the hanger for respectively engaging the dimples of the two ribs, and each orifice has a boss extending from an inner surface of the orifice for buckling on the dimple of a corresponding rib.

13. The container for tool bits as claimed in claim 10 further comprising two ribs extending from the top end of the back plate of the casing, wherein each rib has a dimple defined in a side of the rib, the hanger has two orifices defined in the hanger for respectively engaging the dimples of the two ribs, and each orifice has a boss extending from an inner surface of the orifice for buckling on the dimple of a corresponding rib.

14. The container for tool bits as claimed in claim 11 further comprising two ribs extending from the top end of the back plate of the casing, wherein each rib has a dimple defined in a side of the rib, the hanger has two orifices defined in the hanger for respectively engaging the dimples of the two ribs, and each orifice has a boss extending from an inner surface of the orifice for buckling on the dimple of a corresponding rib.

15. The container for tool bits as claimed in claim 11, wherein each first buckle is a hook and each second buckle is a hook such that each first buckle and a corresponding one of the second buckles are able to hook each other.

16. The container for tool bits as claimed in claim 12, wherein each first buckle is a hook and each second buckle is a hook such that each first buckle and a corresponding one of the second buckles are able to hook each other.

17. The container for tool bits as claimed in claim 13, wherein each first buckle is a hook and each second buckle is a hook such that each first buckle and a corresponding one of the second buckles are able to hook each other.

18. The container for tool bits as claimed in claim 14, wherein each first buckle is a hook and each second buckle is a hook such that each first buckle and a corresponding one of the second buckles are able to hook each other.
